(19) United States
(12) Patent Application Publication
(10) Pub. No.: US 2010/0194554 A1
(43) Pub. Date: Aug. 5, 2010

(54) METHOD AND ARRANGEMENT FOR DETECTING LEAKAGE OF HYDRAULIC OIL

(76) Inventors: Ulrik Algulin, Orebro (SE); Fredrik Grahn, Fjugesta (SE); Anders Hagnelius, Orebro (SE)

Correspondence Address: Mark P Stone, 50 Broadway, Hawthorne, NY, 10532, US

(21) Appl. No.: 12/733,735

(22) PCT Filed: Oct. 20, 2008
(86) PCT No.: PCT/SE2008/000603

§ 371 Date: Mar. 17, 2010

(30) Foreign Application Priority Data
Oct. 18, 2007 (SE) 0702326-0

(51) Int. Cl. B60Q 1/00; G01M 3/00

(52) U.S. Cl. 340/450; 702/51

(57) ABSTRACT

An arrangement for detecting leakage in a hydraulic system of a working vehicle, which hydraulic system comprises a tank (1) for hydraulic oil, hydraulic working means such as hydraulic cylinders (6), which can be acted upon by the hydraulic oil and conduits (7a, 7b) which connect the hydraulic working means (6) to the tank (1), which arrangement for detecting leakage comprises a supervision system (5) and a level sensor (2) which is arranged in the tank (1) to send signals to the supervision system (5) in order to reflect the current hydraulic oil volume in the tank. The supervision system is adapted to using these signals for calculating a volume change rate, and the level sensor (2) is adapted to operating continuously, or at regular brief intervals of time, when the vehicle is in a dynamic state, i.e. when the vehicle is in motion or any of the vehicle's working means (6) are being used. The invention comprises also a working vehicle comprising an arrangement for detecting leakage in a hydraulic system and a method for detecting leakage in such a system.

### TECHNICAL FIELD

The invention relates to a method and an arrangement for detecting leakage in a hydraulic system of a working vehicle such as, for example, a mine loader or a mine truck according to the preambles of the independent claims.

### BACKGROUND

Working vehicles used in, for example, the mining industry comprise usually various working means such as buckets, platforms/boxes or cylinders controlled by hydraulic systems. These hydraulic systems contain a hydraulic liquid, usually oil, which may start leaking, so it is important to have a supervision system to be able to observe whether this happens.

A method for limiting hydraulic oil leakage in a rock-drilling rig is known from EP 1 436 511. The method limits leakage without hindering the various activities in the vehicle which use hydraulic oil. Just before drilling or positioning commences, the oil level in the tank is read and the value is stored in a supervision system. Thereafter the level may be read several times more, e.g. five times, at specified intervals of time. The resulting values serve subsequently as a basis for calculating the volume change rate. With this supervision system, however, it is difficult to detect leakage continuously when the vehicle is in operation and therefore in motion, i.e. when it is moving or substantial parts of it, such as a platform/box or a bucket, are being manoeuvred.

A disadvantage of known solutions is that leaks are only detected at a late stage when considerable amounts of oil have already escaped into the surroundings, adversely affecting the environment.

### BRIEF DESCRIPTION OF THE INVENTION

A problem of known methods for detecting leakage of hydraulic oil is that any leakage is detected late and that it is difficult to detect leakage when the vehicle is in operation, i.e. when it is moving or substantial parts of it, such as a platform/box or a bucket, are being manoeuvred. The object of the invention is to propose an arrangement and a method which solves these problems.

According to a first aspect, the invention relates to an arrangement for detecting leakage in a hydraulic system of a working vehicle such as a mine loader, often referred to as an LHD (Load Haul Dump) vehicle, or a mine truck for carrying blasted-out material away from the mine Such a hydraulic system comprises a tank for hydraulic oil, and hydraulic working means such as hydraulic cylinders for manoeuvring, for example, a bucket or platform/box on the working vehicle. These hydraulic working means can be acted upon by the hydraulic oil and conduits which connect the hydraulic working means to the tank and to a pump for pressurising the hydraulic oil, and the arrangement for detecting leakage comprises a supervision system and a level sensor which is arranged in the tank to send signals to the supervision system which reflect the respective hydraulic oil level representing a hydraulic oil volume in the tank. The supervision system is adapted to using these signals for calculating a volume change rate, and the level sensor is adapted to being able to operate continuously, or at regular brief intervals of time, throughout the time when the vehicle is in a dynamic state, i.e. when the vehicle moves, e.g. along a mine tunnel, or any of the vehicle's working means are being used.

According to a second aspect, the invention relates to a method for detecting leakage in a hydraulic system of a working vehicle such as a mine loader, often referred to as an LHD vehicle, or a mining truck for carrying blasted-out material away from the mine Such a hydraulic system comprises a tank for hydraulic oil, and hydraulic working means such as hydraulic cylinders for manoeuvring, for example, a bucket or platform/box on the working vehicle. These hydraulic working means can be acted upon by the hydraulic oil and conduits which connect the hydraulic working means to the tank and to a pump for pressurising the hydraulic oil, which method for detecting leakage comprises the following steps: continuously or at regular brief intervals of time estimating the current value for hydraulic oil volume in the tank and creating a set of measured values for hydraulic oil volume over a certain period of time. The method calculates a value for the volume change rate of the hydraulic oil from the created set of measured values over said period of time and compares the volume change rate with a certain threshold value in order to detect any leakage in the hydraulic system, and the method steps are executed when the vehicle is in a dynamic state, i.e. when the vehicle moves, e.g. along a mine tunnel, or any of the vehicle's working means are being used.

The problem of achieving reliable detection even when the vehicle is in operation and therefore in motion, i.e. when it is moving or substantial parts of it, such as a platform/box or a bucket, are being manoeuvred, is thus solved. The invention can also detect leaks at an early stage. Thus hydraulic oil spillage costs are reduced and the environment is protected.

### BRIEF DESCRIPTION OF THE DRAWINGS

The invention is explained in more detail below with reference to the drawings, in which:

FIG. 1 depicts an arrangement for detecting hydraulic oil leakage,

FIG. 2 depicts a schematic diagram of a method for detecting hydraulic oil leakage.

### DETAILED DESCRIPTION OF EMBODIMENTS OF THE INVENTION

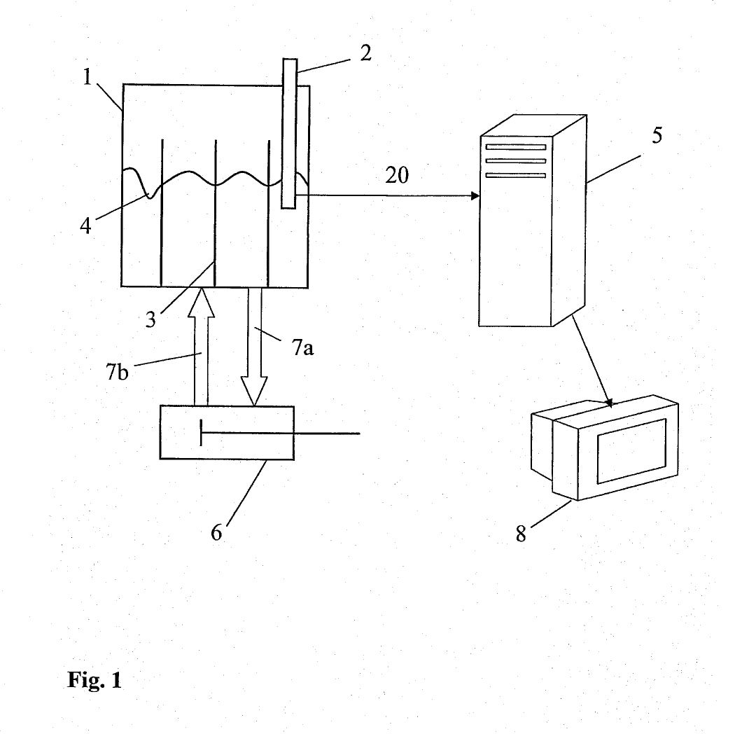

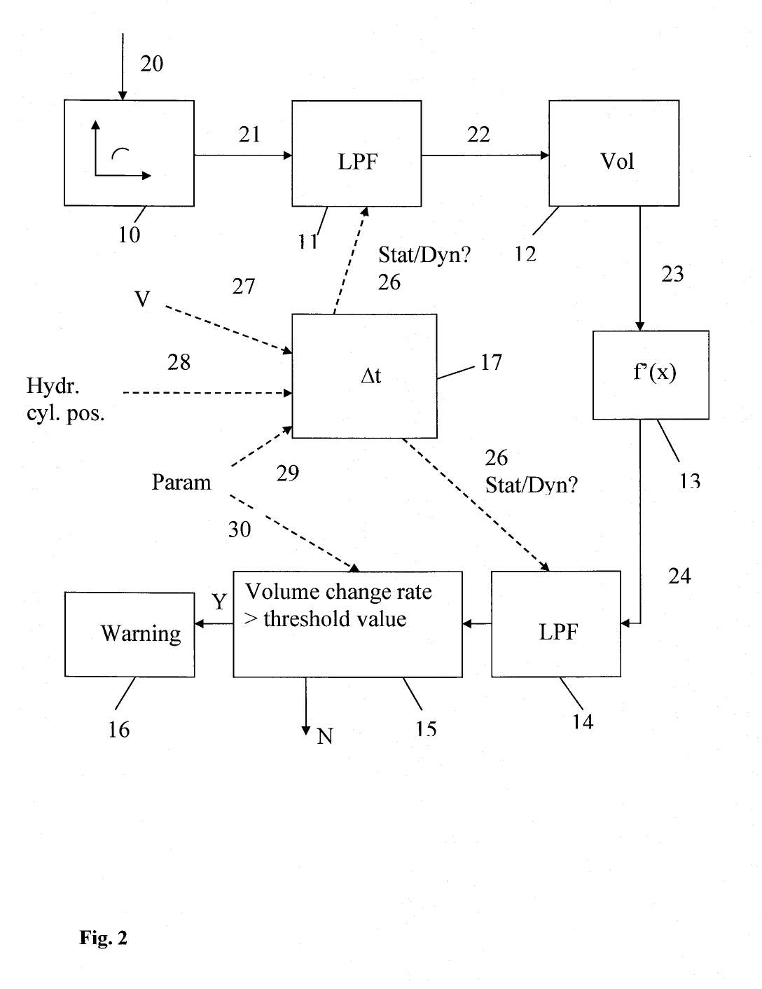

FIG. 1 depicts an arrangement for detecting hydraulic oil leakage. A hydraulic oil tank 1 in a working vehicle has a level sensor 2 for measuring the oil level 4. Conduits 7a, 7b are connected between the tank 1 and the vehicle's working means such as, for example, hydraulic cylinders 6 to enable oil to circulate to and from the cylinders 6, which are controlled via a control system. FIG. 1 is schematic and does not show details such as a pump for pressuring the hydraulic oil from the tank, and valves for controlling the flow of the oil. The level sensor 2 sends signals 20 continuously to a supervision system 5 which analyses the signals in order to monitor the current volume in the tank and see whether it changes, using the method illustrated in FIG. 2 and described below. The supervision system 5 is connected to a user interface 8 which may at its simplest take the form of a warning lamp and/or a warning buzzer. The supervision system 5 may also be connected to or form part of the vehicle's control system.

The method is usable whatever the size or geometry of the tank in the respective vehicle. A calibration has first to be carried out to determine what actual volumes in the tank a number of measured values correspond to. A calibration table 10 is compiled on the basis of this calibration and is stored in the supervision system 5. From the level sensor 2 a reference signal is sent in the form of, for example, a voltage which corresponds to a certain volume of oil in the specific tank. A hydraulic oil volume corresponding to the reference signal is calculated by, for example, linear interpolation between voltage values in the calibration table 10 which are close to the reference signal. A number of successive volume values are stored in the supervision system 5. These values represent oil volume variation over time. A volume change rate 13 is thereafter calculated from these stored volume values by derivation.

A problem of conventional methods for estimating the volume in the hydraulic tank is that they cannot provide reliable values when the vehicle is in operation, i.e. when it is moving or substantial parts of it, such as a platform/box or a bucket, are being manoeuvred and the oil therefore splashes in the tank. In the tank 1 there are therefore 3 bulkheads to damp the splashing and help incoming warm oil to mix with cooler oil in the tank before it is returned to the working vehicle's hydraulic system via the hydraulic pump. The method according to the invention makes it possible to reliably measure volumes in the oil tank even when the vehicle is in operation. This is achieved by the level sensor in the tank continuously sending voltage signals 20, e.g. twenty measurements per second, for analysis according to the method in FIG. 2. This may be done, for example, by the supervision unit reading signals from the sensor 2 twenty times per second. The signal 20 is compared with the calibration table 10 via the relationship between measured voltage value and volume, whereby a value for the current volume is obtained after interpolation calculation in the supervision unit. The volume signal 21 is filtered in a first low-pass filter 11. An alternative or supplementary possibility is that the measured values are low-pass filtered directly from the sensor 2. The low-pass filtered volume signals 22 are saved for a certain time, e.g. ten seconds. A pseudo-derivative 13, i.e. the slope of the curve of the measured volume value 12, is thereafter calculated from the measurements in that interval of time 23. The pseudo-derivative 13 thus gives a volume change rate 24 in the tank over that period of time. The values for the volume change rate 24 are in their turn filtered in a second low-pass filter 14. Finally, a comparison 15 of the low-pass filtered volume change rate 25 with a threshold value is carried out. The threshold value is a settable parameter 30. If the volume decreases faster than the threshold value, a warning 16 is sent to the driver in the form of, for example, an acoustic or light signal.

The two different low-pass filtering steps use different parameters 26 depending on whether the vehicle is in dynamic or a static state and thus adapt the filtering to whether the vehicle is in operation or motionless. In the dynamic state a harder filtering is done. The vehicle is in a dynamic state when it is moving or when a hydraulic cylinder is in motion. For the vehicle to be regarded as having reverted to a static state it has to have been motionless and the hydraulic cylinders have to have been in their initial positions during a time lock, i.e. during a certain time which is regulated by a timer 17. The length of the time lock is a settable parameter 29 which can be adapted to prevailing circumstances. The timer 17 uses the value of the vehicle's speed 27 and the positions of the hydraulic cylinders 28 to decide whether the state of the vehicle is static or dynamic The volume in the vehicle's tank depends also on the position the hydraulic cylinders are in. When the cylinders 6 are in motion, oil is used and the volume in the tank changes. A cylinder 6 uses most oil when it is fully extended at its outermost reversing position and less oil the nearer it comes to the initial position. The supervision system 5 receives information about the positions the cylinders 6 are in and uses that information to determine a nominal volume in the tank 1. The oil volume in the tank is changed by movement of the cylinders 6. The method takes this into account in calculating a nominal volume change rate which is independent of the movement of the cylinders. This makes it possible to detect volume decreasing in an unexpected way, which may indicate leakage. In the static state, no account is taken of the positions of the cylinders, since they will then not vary. An alternative way of incorporating the cylinder positions in nominal volume change rate calculations may be to have the threshold value for the volume change rate vary according to the positions of the cylinders.

The method according to the invention, whereby the volume signal is low-pass filtered twice, both before and after calculating the pseudo-derivative, effectively filters out disturbances in the signal. The result is that if leakage occurs, the signs that oil is escaping can reliably be picked up at an early stage. Disturbances in the signal which lead to deviant values due, for example, to splashing in the tank thus have less impact on the estimated volume values and do not cause misleading results in volume change rate calculations.

The conditions of the place where the vehicle is situated may vary greatly: it may for example be a cramped mine tunnel or an open space above ground. It is therefore difficult to determine a general measure to cater for a number of different scenarios for a working vehicle upon leakage in the hydraulic system. In a cramped mine tunnel it may be more important that the vehicle can be driven away rather than being automatically being switched off and motionless, which would risk the driver being shut in or might make it impossible for another vehicle to be driven in the tunnel. Upon any leakage of hydraulic oil, the driver therefore receives only warning in the form of, for example, a signal which may be an acoustic or light signal. No other measures are taken automatically and it is the driver who decides whether the vehicle should proceed further or immediately halt.

The embodiments described are only to be regarded as examples of possible versions of the invention. Other versions within the scope of the claims may arise.

1. An arrangement for detecting leakage in a hydraulic system of a working vehicle such as mine loader or a mine truck, which hydraulic system comprises:
a tank for hydraulic oil,
hydraulic working means, such as hydraulic cylinders, which can be acted upon by the hydraulic oil and are adapted to maneuvering a means in the working vehicle such as a bucket or a platform/box,
conduits which connect the hydraulic working means to the tank,
which arrangement for detecting leakage comprises:
a supervision system and
a level sensor which is arranged in the tank and connected for signaling purposes to the supervision system and adapted to providing the supervision system with a measurement signal representing a current hydraulic oil volume in the tank,
the working vehicle being further said to be in a dynamic state substantially when the vehicle moves or any of the vehicle's working means are being used, and in a static state substantially when the vehicle is motionless and its working means are not being used, wherein the level sensor is adapted to operating continuously, or at regular brief intervals of time, when the vehicle is in a dynamic state and further in that the supervision system comprises:
a calibration table with a number of volume values corresponding to a number of measurement signal values,
a calculation algorithm for calculating current volume values from current measurement signal values and for storing a sequence of volume values thus calculated,
means for calculating a volume change rate from said stored volume values and comparing the volume change rate with a certain threshold value in order to detect any leakage in the hydraulic system, and
means for low-pass filtering of the signal from said level sensor and/or a partial result from the supervision system's calculation arising from said signal.

2. An arrangement for detecting leakage according to claim 1, wherein the supervision system comprises means for calculating a nominal volume change rate, which means is, in the dynamic state, adapted to doing the calculation in a manner related to the positions of the working means and to issuing a warning if the nominal volume change rate exceeds a certain threshold value which indicates that there is leakage in the hydraulic system.

3. An arrangement for detecting leakage according to claim 1, wherein the means for low-pass filtering are adapted to using different parameters depending on whether the vehicle is in a static or a dynamic state.

4. An arrangement for detecting leakage according to claim 1, wherein the means for low-pass filtering are adapted to filtering not only the signal from the level sensor and/or calculated volume signals but also a calculated volume change rate.

5. A working vehicle such as a mine loader or a mine truck comprising an arrangement for detecting leakage according to claim 1.

6. A method for detecting leakage in a hydraulic system of a working vehicle such as a mine loader or a mine truck, which hydraulic system comprises:
a tank for hydraulic oil,
hydraulic working means, such as hydraulic cylinders, which can be acted upon by the hydraulic oil and are adapted to maneuvering a means in the working vehicle such as a bucket or a platform/box,
conduits which connect the hydraulic working means to the tank,
a supervision system and
a level sensor which is arranged in the tank and connected for signaling purposes to the supervision system and adapted to providing the supervision system with a measurement signal representing a current hydraulic oil volume in the tank,
the working vehicle being further said to be in a dynamic state substantially when the vehicle moves or any of the vehicle's working means are being used, and in a static state substantially when the vehicle is motionless and its working means are not being used,
wherein the level sensor is adapted to operating continuously, or at regular brief intervals of time, when the vehicle is in a dynamic state and further in that the method comprises the following steps:
calculating a current volume value from a current measurement signal value and a calibration table comprising a number of volume values corresponding to a number of measurement signal values,
storing a sequence of such calculated volume values,
calculating a volume change rate from said stored volume values,
comparing the volume change rate with a certain threshold value in order to detect any leakage in the hydraulic system, and
low-pass filtering of the signal from said level sensor and/or a partial result from the supervision system's calculation arising from said signal.

7. A method for detecting leakage according to claim 6, wherein the supervision system is caused to calculate a nominal volume change rate and, in the dynamic state, to calculate said nominal volume change rate in relation to the positions of the working means, and further to issue a warning if the nominal volume change rate exceeds a certain threshold value which indicates that there is leakage in the hydraulic system.

8. A method according to claim 6, wherein the low-pass filtering is done with different filter constants depending on whether the vehicle is in a static or a dynamic state.

9. An arrangement for detecting leakage according to claim 2, wherein the means for low-pass filtering are adapted to using different parameters depending on whether the vehicle is in a static or a dynamic state.

10. An arrangement for detecting leakage according to claim 2, wherein the means for low-pass filtering are adapted to filtering not only the signal from the level sensor and/or calculated volume signals but also a calculated volume change rate.

11. An arrangement for detecting leakage according to claim 3, wherein the means for low-pass filtering are adapted to filtering not only the signal from the level sensor and/or calculated volume signals but also a calculated volume change rate.

12. An arrangement for detecting leakage according to claim 9, wherein the means for low-pass filtering are adapted to filtering not only the signal from the level sensor and/or calculated volume signals but also a calculated volume change rate.

13. A working vehicle such as a mine loader or a mine truck comprising an arrangement for detecting leakage according to claim 2.

14. A working vehicle such as a mine loader or a mine truck comprising an arrangement for detecting leakage according to claim 3.

15. A working vehicle such as a mine loader or a mine truck comprising an arrangement for detecting leakage according to claim 4.

16. A working vehicle such as a mine loader or a mine truck comprising an arrangement for detecting leakage according to claim 9.

17. A working vehicle such as a mine loader or a mine truck comprising an arrangement for detecting leakage according to claim 12.

18. A method according to claim 7, wherein the low-pass filtering is done with different filter constants depending on whether the vehicle is in a static or a dynamic state.
